(19) United States
(12) Patent Application Publication
(10) Pub. No.: US 2008/0190261 A1
(43) Pub. Date: Aug. 14, 2008

(54) PIANO

(75) Inventors: Susan Yake Kenagy, Huntington Station, NY (US); Robert F. Dove, Stamford, CT (US); James M. Lombino, Ashfield, MA (US)

Correspondence Address: FISH & RICHARDSON PC, P.O. BOX 1022, MINNEAPOLIS, MN, 55440-1022, US

(73) Assignee: STEINWAY MUSICAL INSTRUMENTS, INC., Waltham, MA (US)

(21) Appl. No.: 12/025,106

(22) Filed: Feb. 4, 2008

Related U.S. Application Data
(60) Provisional application No. 60/889,045, filed on Feb. 9, 2007.

(51) Int. Cl. G10C 3/02; G03G 15/16

(52) U.S. Cl. 84/177; 399/307

(57) ABSTRACT

A piano (upright or horizontal) including a piano case having a case surface temporarily adhering markings. An upright piano including a piano case having a reversible display panel selectively positionable among a display position and a marking position. The panel has a decorative display side and a markable side, which temporarily adheres markings. The decorative display side faces outward while in the display position and the markable side faces outward while in the marking position.

### CROSS REFERENCE TO RELATED APPLICATIONS

This U.S. patent application claims priority under 35 U.S.C. § 119(e) to U.S. Provisional Application 60/889,045, filed on Feb. 9, 2007. The disclosures of the prior application is considered part of and is hereby incorporated by reference in the disclosure of this application.

### TECHNICAL FIELD

This invention relates to pianos.

### BACKGROUND

A piano is a musical instrument that produces sound by striking steel strings with felt hammers that immediately rebound allowing the string to continue vibrating. These vibrations are transmitted through bridges to a soundboard, which amplifies the vibrations. Upright pianos, also called vertical pianos, are more compact than grand pianos (horizontal pianos) because the frame and strings are placed vertically, extending in both directions (up and down) from the keyboard and hammers.

### SUMMARY

In one aspect, an upright piano includes a piano case having a panel, e.g. an upper front panel, selectively positionable among a display position and a marking position, which temporarily adheres markings. The panel has a decorative display side and a markable side. The decorative display side faces outward while in the display position and the markable side faces outward while in the marking position.

In another aspect, a piano, e.g. a grand or horizontal piano, includes a piano case having a reversible music desk selectively positionable among a display position and a marking position, which temporarily adheres markings. The reversible music desk has a decorative display side and a markable side. The decorative display side faces outward while in the display position and the markable side faces outward while in the marking position.

In yet another aspect, a piano includes a piano case having a case surface temporarily adhering markings. The piano may be either horizontal or upright, for example.

Implementations of the disclosure may include one or more of the following features. The markable surface (e.g. markable side of the panel, music desk, or piano case) may be porcelain enameled steel, melamine board, or a material that resists ghosting from an erasable marker. In one example, the markable surface includes a phenolic board having an inert polyester urethane acrylate coating. In some examples, the markable decorative display sides of the reversible display panel have different surface colors. The markable surface may be substantially white, black, or a combination of colors. The markable surface may also include a substantially permanent image. For example, the decorative display side of the panel or music desk may include a substantially permanent image. The decorative display side may be configured to temporarily adhere markings as well. In some examples, the case of the piano and/or the reversible panel has a polyester finish (e.g. a white polyester finish on the markable side and a black polyester finish on the decorative side).

In some implementations, the piano case defines first and second guided paths configured to receive and retain the panel. In one example, the first and second guided paths are grooves defined by the piano case. In another example, the guided paths include a parallel series of protrusions (e.g. pegs).

In another aspect, a method of positioning a reversible panel temporarily retained by first and second guided paths defined by an upright piano case includes lifting the panel upward and out of the guided paths, positioning the panel among a display position and a marking position, aligning the panel with the guided paths, and sliding the panel down into the first and second guided paths.

In one aspect, a method of finishing a piano includes printing an ink image onto a transfer sheet, applying the printed transfer sheet to an inert polyester urethane acrylate coated phenolic surface of the piano, and removing the transfer sheet from the piano surface. The method further includes applying the transfer sheet under sufficient heat and pressure to merge the ink image with the coating.

In yet another aspect, a method of making a reversible panel, e.g. an upper front panel, for an upright piano includes printing an ink image onto a transfer sheet, applying the printed transfer sheet to an inert polyester urethane acrylate coated phenolic panel sized to be received by the upright piano, and removing the transfer sheet from the panel. The method further includes applying the transfer sheet under sufficient heat and pressure to merge the ink image with the coating.

The details of one or more implementations of the disclosure are set fourth in the accompanying drawings and the description below. Other features, objects, and advantages will be apparent from the description and drawings, and from the claims.

### DESCRIPTION OF DRAWINGS

FIG. 1 is a front view of an upright piano.

FIG. 2 is a side view of an upright piano.

FIG. 3 is an exploded view of an upright piano.

FIG. 4 is a front view of a front panel of an upright piano.

FIG. 5 is a rear view of a front panel of an upright piano.

FIG. 6 is an exploded view of an upright piano.

FIG. 7 is an exploded view of an upright piano.

FIG. 8 is a perspective view of a piano.

FIG. 9 is an exploded view of a piano.

Like reference symbols in the various drawings indicate like elements.

### DETAILED DESCRIPTION

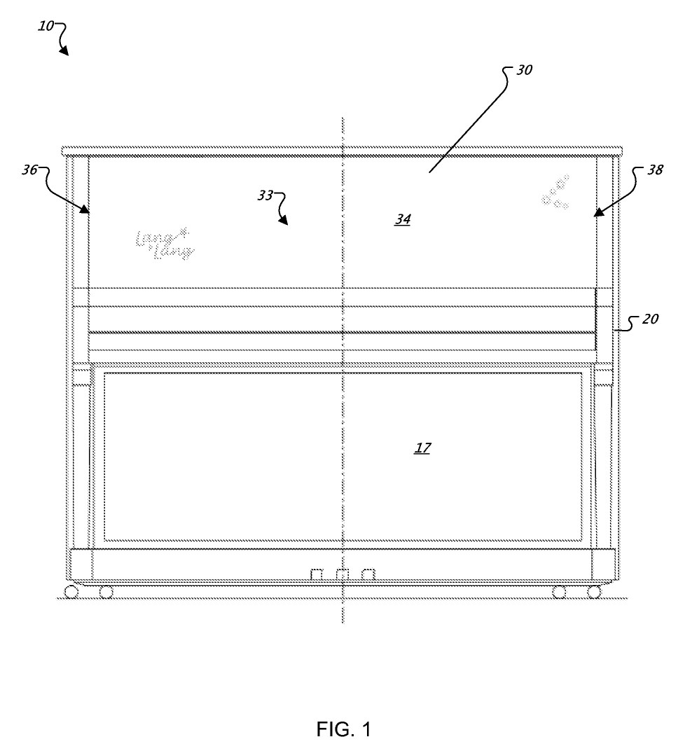

Referring to FIGS. 1-3, an upright piano 10 includes a piano case 20 having an upper front panel 30 selectively positionable among a display position 31 and a marking position 33. The upper front panel 30 includes a decorative display side 32 and a markable side 34. The decorative display side 32 faces outward while in the display position 31 and the markable side 34 faces outward while in the marking position 33. The markable side 34 allows markings to temporarily adhere to the surface of the markable side 34, preferably without significant ghosting.

In one implementation, the markable side 34 is a dry-erase or dry-wipe board having a glossy surface amenable to temporary markings. In one instance, the markable side 34 of the upper front panel 30 includes porcelain enameled steel. In another instance, the markable side 34 of the upper front panel 30 includes melamine board. In yet another instance, the markable side 34 of the upper front panel 30 includes a material that substantially resists ghosting from an erasable marker. In some examples, an inert polyester urethane acrylate coating is cured with an electron beam on a phenolic laminate of about 0.060 inch (1.5 mm). The coating provides a high quality imageable surface with ultra-violet light blockers to minimize ink fading and provides excellent scratch and abrasion resistance. The glossy surface is generally colored white or black, but may be any other color or combination of colors, as desired. In other examples, a polyester finish (e.g. polished polyester resin coating) is applied to the decorative display side 32 and/or the markable side 34 of the upper front panel 30. One side 32, 34 may be colored black, while the other side 32, 34 is colored white. With a polyester finish, the decorative display side 32 and/or the markable side 34 may be configured to temporarily adhere markings. Preferably, the upper front panel 30 is coated with a polyester resin coating (e.g. by a curtain flow coater) to make an under-layer invisible. The polyester resin coating is polished to provide a desired finish. In some examples, an unsaturated polyester resin is sprayed on and allowed to dry. This process may be repeated for several coats. The polyester resin coat(s) are sanded smooth, using a progression of abrasives, from course to smooth.

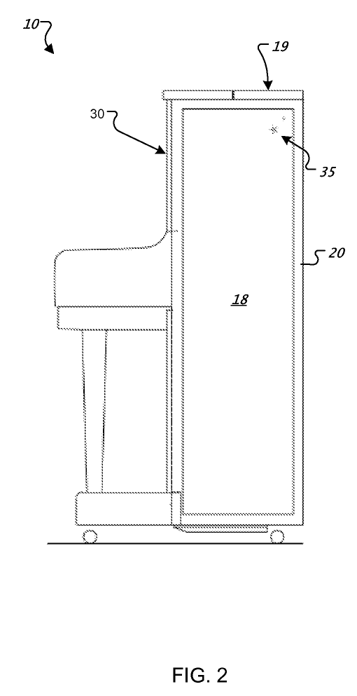

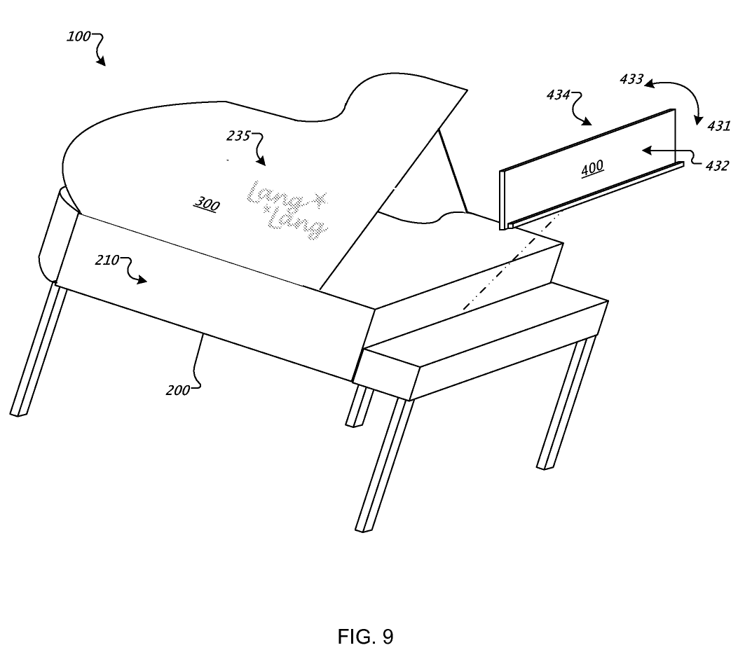

In some implementations, one or more other panels, e.g. lower front panel 17, a portion of the piano case 20, or the entire piano case 20 may have a markable surface that allows temporary adherence of markings. For example, the sides 18 and/or top 19 of the piano case 20, as shown in FIG. 2, may include an inert polyester urethane acrylate coating or other markable dry-erase type surface. The sides 18 and/or top 19 of the piano case 20 may also include images 35. Markable surfaces may be included on any portion of either an upright piano as shown in FIG. 1 or a horizontal piano 100 as shown in FIG. 8, for example.

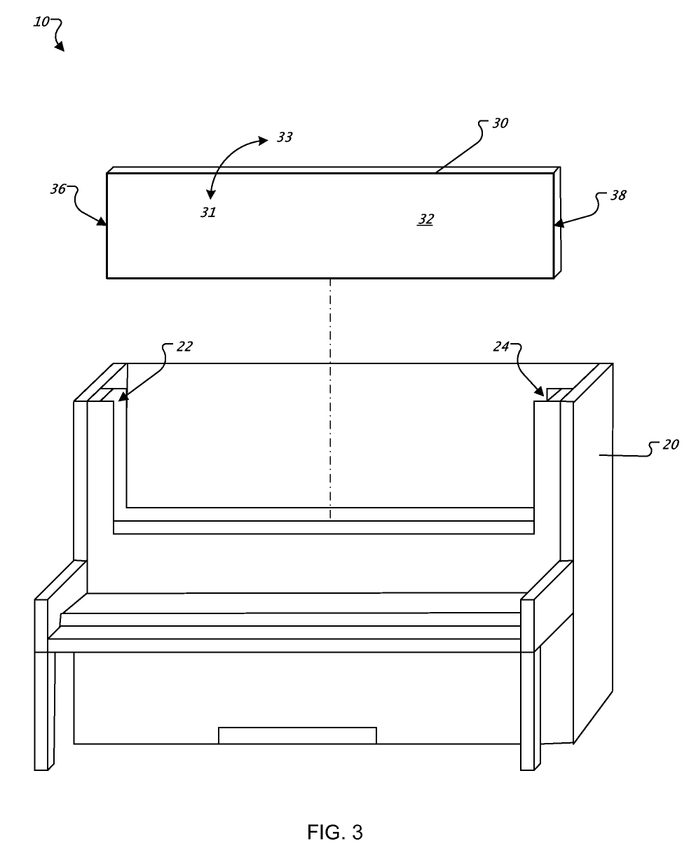

Referring to FIG. 3, the piano case 20 defines first and second guided paths 22, 24, respectively, configured to receive and retain first and second ends 36, 38 of the upper front panel 30. In one example, the first and second guided paths 22, 24, respectively, are substantially vertical grooves defined by the piano case 20. The upper front panel 30 is temporarily retained by the guided paths 22, 24 by holding the upper front panel 30 above and aligned with the guided paths 22, 24, and sliding the first and second ends 36, 38 of the upper front panel 30 downward into the first and second guided paths 22, 24, respectively. The upper front panel 30 is positionable among the display position 31 and the marking position 33 by sliding the upper front panel 30 out of the guided paths 22, 24, rotating the upper front panel 30 by 180° and sliding the upper front panel 30 back down into the guided paths 22, 24.

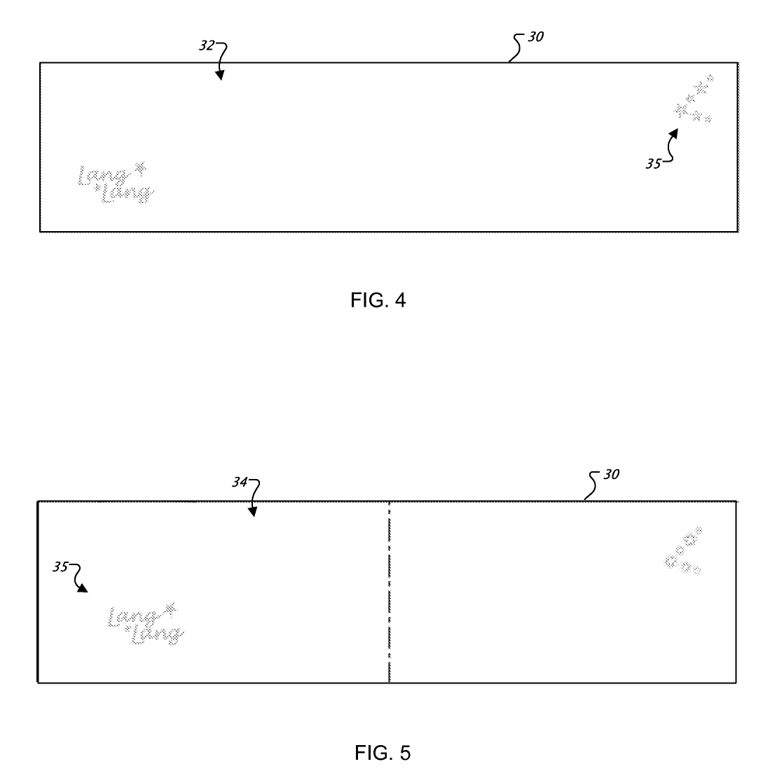

Referring to FIGS. 4-5, in some implementations, a permanent image 35 is displayed on the surface of the markable side 34, the surface of the decorative display side 32, and/or on other surfaces (e.g. sides 18 or top 19) of the piano 10. One example of providing an upper front panel 30 having an image includes printing an image 35 (e.g. inkjet, offset, or other method) onto a transfer sheet using dye sublimation inks. One transfer sheet is used for each printed panel 30. The printed transfer sheet is applied under heat and pressure to an upper front panel 30 formed of phenolic material with an inert polyester urethane acrylate coating. The dye sublimation inks, activated by the heat and pressure, merge with the coating at the molecular level and become integral with the material. The transfer sheet is then removed and discarded. This image transfer method may be used on any surface of the piano 10.

Dry-erase ink markings are less susceptible to external factors, such as water or accidental erasure, because the ink adheres slightly more strongly than chalk does to chalkboards. Furthermore, using dry-erase markers does not generate the dust that comes from using and erasing chalk, thereby reducing potential allergic reactions.

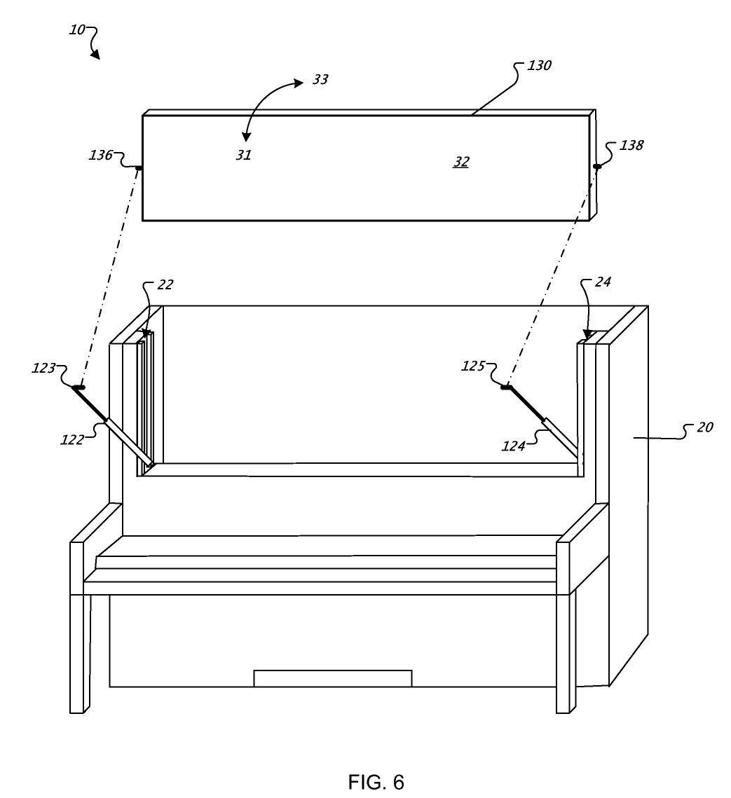

Referring to FIG. 6, in another implementation, the upper front display panel 130 may be pivotably mounted to pivot support arms 122, 124 that are drawn from the piano case 20 as the upper front display panel 130 is lifted. When the upper front display panel 130 is clear of the piano case guides 22, 24, with the pivot support arms 122, 124 fully extended, the pane 130, mounted on pins 123, 125 extending from the support arms 122, 124, is rotated 180° to selectively change the panel surface to be displayed, i.e. between display surface 32 and marking surface 34. The upper front panel 130 is then re-aligned with the guides 22, 24, and the panel 130 and supports 122, 124 are pressed back into the piano case 20. In other implementations, the support arms 122, 124 may be spring-biased to assist in lifting the panel 130 and holding the support arms 122, 124 extended during the process of changing the panel display surface. Locking elements, such as pins or slides may also be provided for securing the front upper panel 130 against movement of vibration in the guides 22, 24.

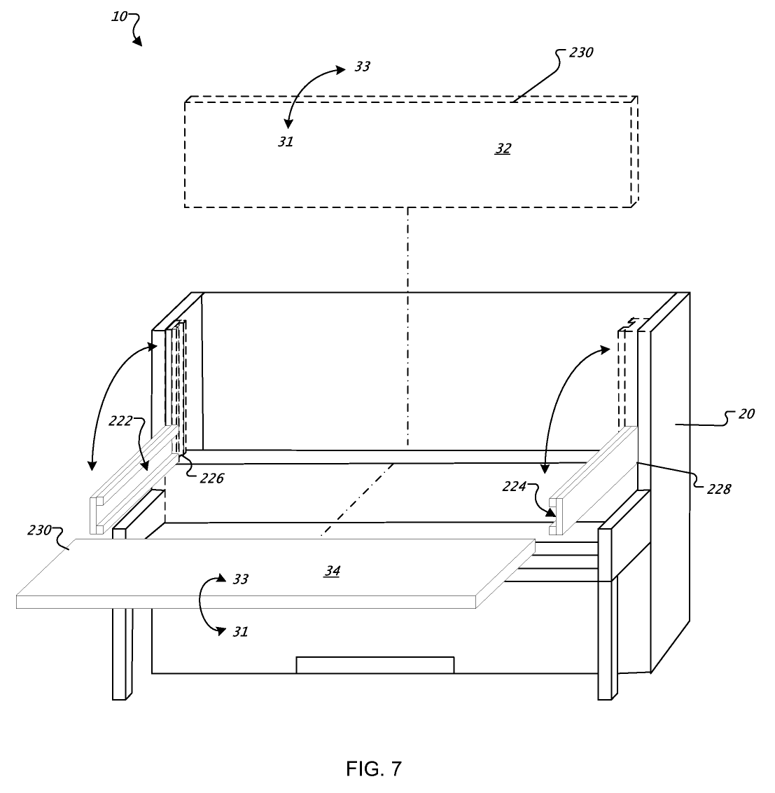

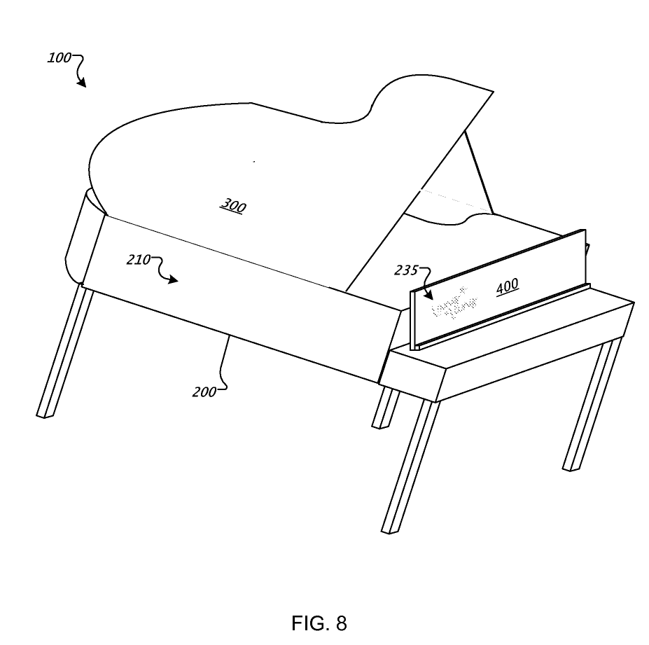

Also, referring to FIG. 7, in still another implementation, the panel edge guides 222, 224 may be defined by hinged or pivoting post elements. To facilitate removal and replacement of the upper front panel 230 during a change of display surface, the panel 140 and post elements pivot forward about hinges or pins 226, 228 at the lower end region of the posts, thereby permitting the upper front panel 230 to be removed and replaced vertically or horizontally at a relatively lower height above the ground.

Referring to FIG. 8, in another implementation, a grand or horizontal piano 100 includes a piano case 200 having a lid 300 and a music desk 400. In some examples, the piano case 200 has a surface 210 that temporarily adheres markings. The case surfaces 210 may include, for example, porcelain enameled steel, melamine board, or phenolic material having an inert polyester urethane acrylate coating. In some instances, the case surface 210 includes a permanent image 235 (e.g. located on the lid 300 or sides of the case 200). The image transfer method described earlier herein may be used on any surface of the piano 100.

Referring to FIG. 9, piano 100 includes a piano case 200 having a lid 300 and a front reversible music desk 400 selectively positionable among a display position 431 and a marking position 433. The front reversible music desk 400 includes a decorative display side 432 and a markable side 434. The decorative display side 432 faces outward while in the display position 431 and the markable side 434 faces outward while in the marking position 433. The markable side 434 allows markings to temporarily adhere to the surface of the markable side 434, preferably without significant ghosting.

A number of implementations have been described. Nevertheless, it will be understood that various modifications may be made without departing from the spirit and scope of the disclosure. For example, images on the upper front panel 30 may cover all or only a portion of either or both of the decorative display side 32 and the markable side 34. Images may be applied to other parts of the piano as well. Accordingly, other implementations are within the scope of the following claims.

What is claimed is:

1. An upright piano comprising a piano case having a reversible display panel selectively positionable among a display position and a marking position, the reversible display panel having a decorative display side and a markable side, the markable side temporarily adhering markings, the decorative display side facing outward while in the display position and the markable side facing outward while in the marking position.

2. The upright piano of claim 1, wherein the markable side of the reversible display panel comprises porcelain enameled steel.

3. The upright piano of claim 1, wherein the markable side of the reversible display panel comprises melamine board.

4. The upright piano of claim 1, wherein the markable side of the reversible display panel comprises a material that resists ghosting from an erasable marker.

5. The upright piano of claim 1, wherein the markable side of the reversible display panel comprises a phenolic panel with an inert polyester urethane acrylate coating.

6. The upright piano of claim 1, wherein the reversible display panel has a polyester finish.

7. The upright piano of claim 1, wherein the markable side of the reversible music desk comprises a substantially white surface.

8. The upright piano of claim 1, wherein the markable side of the reversible display panel comprises a substantially black surface.

9. The upright piano of claim 1, wherein the markable side of the reversible display panel comprises a substantially permanent image.

10. The upright piano of claim 1, wherein the decorative display side of the reversible display panel comprises a substantially permanent image.

11. The upright piano of claim 1, wherein the piano case comprises first and second guided paths configured to receive and temporarily retain the reversible display panel.

12. The upright piano of claim 11, wherein the first and second guided paths comprise grooves defined by the piano case.

13. The upright piano of claim 1, wherein the reversible display panel is an upper front panel.

14. The upright piano of claim 1, wherein the decorative display side is configured to temporarily adhere markings.

15. A method of positioning a reversible display panel temporarily retained by first and second guided paths defined by an upright piano, the method comprising:
removing the reversible display panel out of the guided paths;
selectively positioning the reversible display panel among a display position and a marking position;
aligning the reversible display panel with the guided paths; and
sliding the reversible display panel into the first and second guided paths.

16. A method of making a reversible display panel for an upright piano, the method comprising:
printing an ink image onto a transfer sheet;
applying the printed transfer sheet to a display panel for an upright piano, the display panel being formed of phenolic material and having an inert polyester urethane acrylate coating, the transfer sheet being applied under sufficient heat and pressure to merge the ink image with the coating; and
removing the transfer sheet from the reversible display panel.

17. A piano comprising a piano case having a reversible music desk selectively positionable among a display position and a marking position, the reversible music desk having a decorative display side and a markable side, the markable side temporarily adhering markings, the decorative display side facing outward while in the display position and the markable side facing outward while in the marking position.

18. The piano of claim 17, wherein the markable side of the reversible music desk comprises porcelain enameled steel.

19. The piano of claim 17, wherein the markable side of the reversible music desk comprises melamine board.

20. The piano of claim 17, wherein the markable side of the reversible music desk comprises a material that resists ghosting from an erasable marker.

21. The piano of claim 17, wherein the markable side of the reversible music desk comprises a phenolic panel having inert polyester urethane acrylate coating.

22. The piano of claim 17, wherein the reversible music desk has a polyester finish.

23. The piano of claim 17, wherein the markable side of the reversible music desk comprises a substantially white surface.

24. The piano of claim 17, wherein the markable side of the reversible music desk comprises a substantially black surface.

25. The piano of claim 17, wherein the markable side of the reversible music desk comprises a substantially permanent image.

26. The piano of claim 17, wherein the decorative display side of the reversible music desk comprises a substantially permanent image.

27. The piano of claim 17, wherein the decorative display side is configured to temporarily adhere markings.

28. A piano comprising a piano case having a case surface temporarily adhering markings.

29. The piano of claim 28, wherein the case surface comprises a phenolic material having an inert polyester urethane acrylate coating.

30. The piano of claim 28, wherein the case surface comprises a polyester finish.

31. The piano of claim 28, wherein the case surface comprises porcelain enameled steel.

32. The piano of claim 28, wherein the case surface comprises melamine board.

33. The piano of claim 28, wherein the case surface comprises a material that resists ghosting from an erasable marker.

34. The piano of claim 28, wherein the case surface comprises a substantially permanent image.

35. A method of finishing a piano, the method comprising:
printing an ink image onto a transfer sheet;
applying the printed transfer sheet to a piano surface, the piano surface being formed of phenolic material and having an inert polyester urethane acrylate coating, the transfer sheet being applied under sufficient heat and pressure to merge the ink image with the coating; and
removing the transfer sheet from the piano surface.
